(19) United States
(12) Patent Application Publication
(10) Pub. No.: US 2009/0251005 A1
(43) Pub. Date: Oct. 8, 2009

(54) UNDERVOLTAGE TRANSFER DETECTION

(75) Inventors: Terry D. BUSH, Westerville, OH (US); Brian P. HEBER, Delaware, OH (US); Mohammad Nanda Rahmana MARWALI, Lewis Center, OH (US); Peter A. PANFIL, Columbus, OH (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: LIEBERT CORPORATION, Columbus, OH (US)

(21) Appl. No.: 12/098,638

(22) Filed: Apr. 7, 2008

(51) Int. Cl. H02J 9/00

(52) U.S. Cl. 307/64

(57) ABSTRACT

A method of increasing the reliability of an uninterruptible power supply (UPS) providing AC power to a load, comprising determining the magnitude and duration of an actual undervoltage event in a power output of the UPS; providing a predetermined undervoltage standard establishing at least a range of undervoltage events of acceptable magnitude and duration for the load; comparing the magnitude and duration of the actual undervoltage event with the predetermined standard; and causing the load to be transferred to an alternate source of AC power when the comparison of the actual undervoltage event with the predetermined standard reveals that the actual undervoltage event is not acceptable.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to uninterruptible power supplies and more specifically relate to increasing the reliability of uninterruptible power supplies subject to undervoltage conditions.

2. Description of the Related Art

Critical systems, such as computers and computer-controlled systems, require electrical power of a certain “quality.” “Quality” for alternating current (AC) power has been defined by several associations, such as the Computer and Business Equipment Manufacturers Association (CBEMA) and more recently the Information Technology Industry Counsel (ITIC) and the Semiconductor Equipment and Materials International (SEMI). The CBEMA, for example, developed a graphical relationship establishing a “power quality envelope,” showing the acceptable undervoltage and overvoltage conditions that most equipment can tolerate for a given period of time. For example, for events longer than one second, CBEMA-compliant equipment must tolerate up to 106% overvoltage and 87% undervoltage conditions.

The most typical power quality problems are undervoltage (sags), spikes and surges, overvoltage, noise, and blackouts. Sags, brownouts, and blackouts are all under-voltage conditions. Sags, depending on their magnitude and duration, can cause interruption in function of electronic devices. Brownouts, typically under-voltage events lasting up to several seconds, may also adversely affect electronic equipment. Blackouts, or long periods of interrupted electrical service, often completely shut-down electronic devices, unless alternative power is readily available.

Not surprisingly, then, Uninterruptible Power Systems (UPS) are an indispensable part of many data processing installations and are subject to power quality issues, such as those discussed above. The continually increasing use of computer-based control systems in manufacturing and process control applications has increased the use of UPS in industrial facilities as well.

It is now common for UPS to utilize Insulated Gate BiPolar Transistor (IGBT) inverter sections to generate AC power for the UPS-supplied load. During transfers from primary power to bypass power caused by a UPS output undervoltage condition, the inverter section and bypass power source necessarily operate in parallel during the time required to open the UPS output circuit breaker or contactor. This overlap can easily approach 50 to 100 milliseconds, depending on the operating speed of the particular device employed. Inverter switching device (IGBT) failures can occur when the inverter and bypass power source operate in parallel and current is back fed from the bypass source into the inverter section.

The inventions disclosed and taught herein are directed to a method and system of delaying the transfer to the bypass source in response to a UPS output undervoltage to allow the UPS system to recover from the undervoltage condition before transferring to the bypass power source.

### BRIEF SUMMARY OF THE INVENTION

In one aspect of the present inventions, a method of increasing the reliability of an uninterruptible power supply (UPS) providing alternating current (AC) power to a load, comprising determining the magnitude and duration of an actual undervoltage event in a power output of the UPS; providing a predetermined undervoltage standard establishing at least a range of undervoltage events of acceptable magnitude and duration for the load; comparing the magnitude and duration of the actual undervoltage event with the predetermined standard; and causing the load to be transferred to an alternate source of AC power when the comparison of the actual undervoltage event with the predetermined standard reveals that the actual undervoltage event is not acceptable.

### BRIEF DESCRIPTION OF THE SEVERAL VIEWS OF THE DRAWINGS

FIG. 1 illustrates the Computer and Business Equipment Manufacturers Association (CBEMA) power quality standard that may be used with embodiments of the invention.

FIG. 2 illustrates the Information Technology Industry Counsel (ITIC) power quality standard that may be used with embodiments of the invention.

FIG. 3 illustrates a generic Uninterruptible Power System (UPS) for use with the present invention.

FIG. 4 illustrates a silicon-controlled rectifier (SCR) transfer switch for use with the present invention.

FIG. 5 illustrates a circuit for comparing an undervoltage event with a power quality standard.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

In general, the invention disclosed and taught herein may be embodied in various methods or processes that delay the transfer of a load to a bypass power source in instances of Uninterruptible Power System (UPS) faults, overloads and other such transients that result in a temporary UPS output undervoltage. The invention comprises, detecting an power quality event in a UPS inverter output; the magnitude and duration of the power quality event is determined and compared to a predetermined standard or criteria, such as, the Computer and Business Equipment Manufacturers Association (CBEMA) power quality curve, the Information Technology Industry Counsel (ITIC) power quality curve quality curve, or the Semiconductor Equipment and Materials International (SEMI) E10 power standard; and the transfer of the load to from the primary power source to the bypass source is delayed based on the comparison. As but one example, so long as the event does not violate the predetermined standard, transfer is inhibited. In other words, only when the power quality event actually meets the predetermined standard is the transfer initiated. In this way, the UPS inverter section's exposure to the possibly damaging condition of operating in parallel with the bypass power source will be minimized, thus increasing the overall system reliability.

The invention also may be embodied in various devices or systems that compare, for example, the RMS output voltage of a UPS to a pre-determined power standard, such as, but not limited to the CBEMA voltage vs. time curve for acceptable power quality conditions. So long as the undervoltage event does not actually meet the pre-determined standard, transfer of the load to the bypass power source is not initiated. Rather, transfer is preferably delayed until the event actually meets the pre-determined standard, thereby avoiding unnecessary transfer.

It will now be appreciated that allowing the UPS output voltage to vary within the predetermined standard allows the possible recovery of the UPS system in transient system faults and temporary overloads such that the transfer to bypass power is prevented. This eliminates the occurrence of operating the inverter in parallel with the bypass source and thus risking the event of an inverter device failure. This also eliminates other problems associated with transfers, such as high saturation currents and other problems associated with the different phases of the power supplied by the UPS and that of the bypass power source.

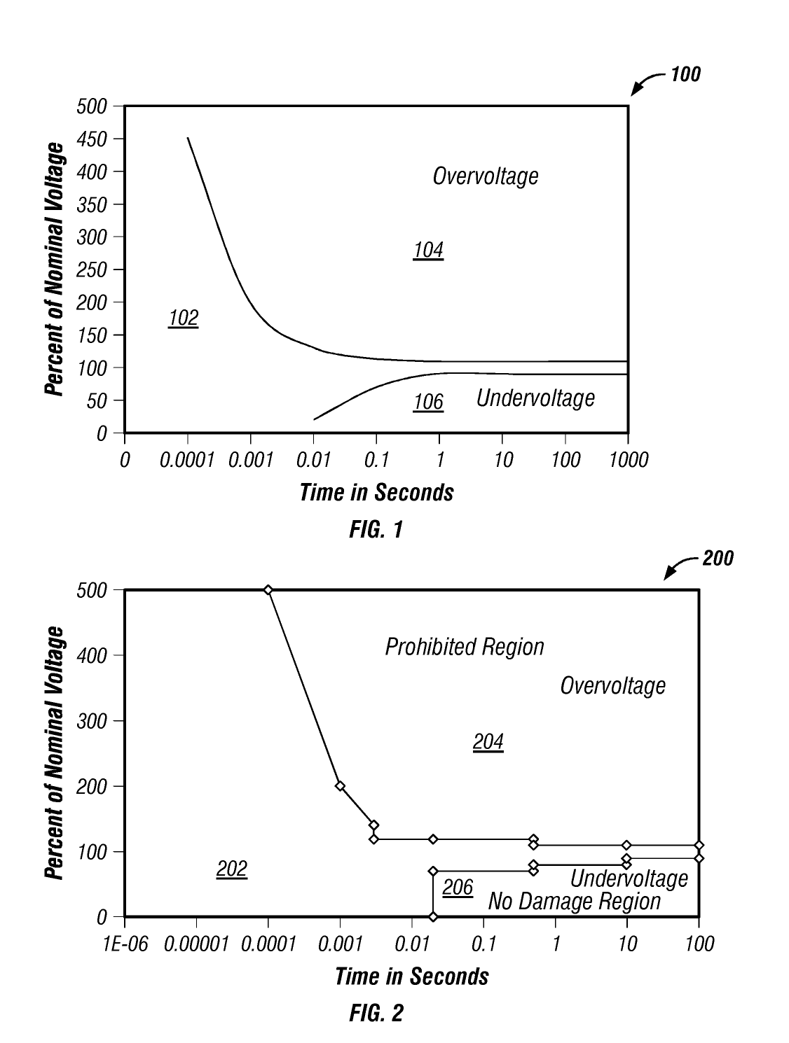

FIG. 1 illustrates the CBEMA power quality standard 100. The standard is a susceptibility profile, with the vertical axis representing the percent of nominal voltage applied to the load measured as rms voltage or a peak voltage equivalent and the horizontal axis representing the duration of the voltage event in seconds or cycles. In the center of the plot is an acceptable area 102 of under and overvoltage events of specific duration. Outside of the curves bounding this acceptable power area 102 is an unacceptable overvoltage area 104 and an unacceptable undervoltage area 106.

Similarly, FIG. 2 illustrates the more recent ITIC power quality standard 200. Again, the vertical axis represents the percent of nominal voltage applied to the load measured as rms voltage or a peak voltage equivalent and the horizontal axis represents the duration of the voltage event in seconds or cycles. In the left-center of the plot is an acceptable area 202 of under and overvoltage events of specific duration. Outside of the curves bounding this acceptable power area 202 is an unacceptable overvoltage area 204 and an unacceptable undervoltage area 206.

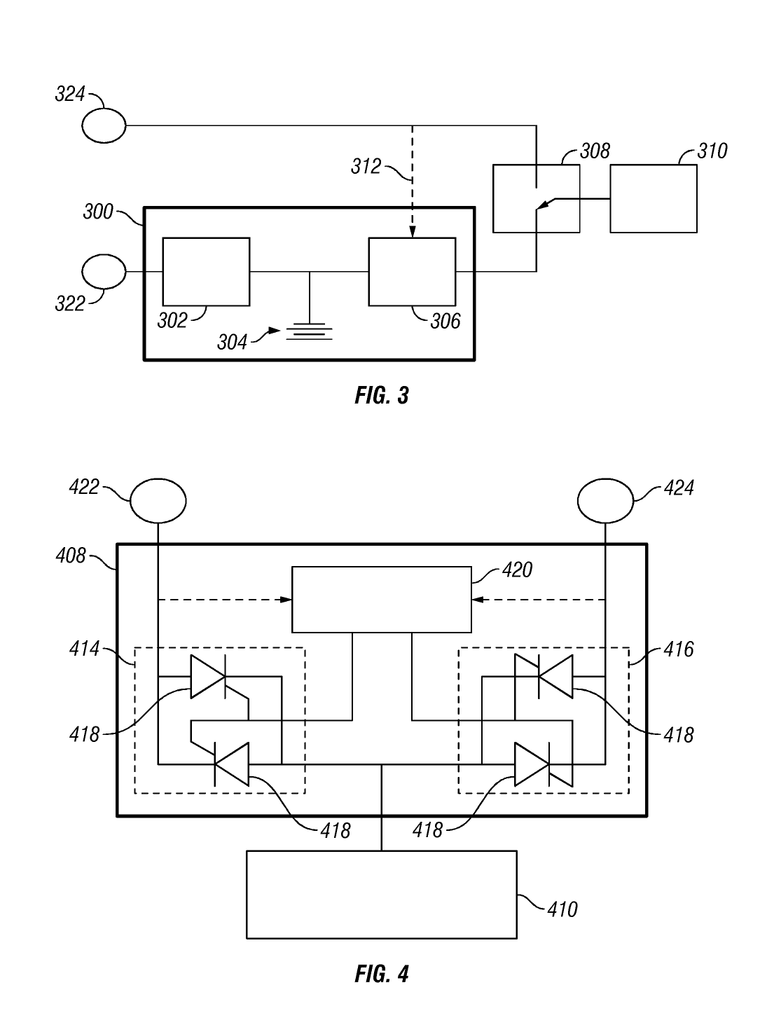

Turning now to a more detailed description of at least one embodiment of the present inventions, FIG. 3 illustrates a generic UPS 300 connected to a primary single phase or multi-phase alternating current (AC) source 322. A converter or regulator section 302 converts the AC power into direct current (DC) power, or a reasonable facsimile of DC power. A battery 304 or other UPS backup power source may be provided. The DC power may be used to charge the battery 304 and is otherwise fed to an inverter section 306 which transforms the DC power back into an acceptable form of AC power. The AC power is then fed to a transfer switch 308, such as a contactor, that selectively connects a load 310 to either the AC power supplied by the UPS 300 or to an alternate or bypass AC source 324 if and when the primary AC source 322 fails or is otherwise unacceptable. Inverter section 306 may accept a synchronizing input 312 from alternate AC source 324 to minimize disruption to the load 310 during and after transfer.

FIG. 4 illustrates a solid state form of transfer switch 408 for a single phase of AC power comprising two switches 414 and 416, with each switch comprising Silicon-Controlled Rectifiers (SCR) 418. A sensing and logic section 420 is also provided for turning switches 414 and 416 on and off in response to pre-determined conditions. For example, the sensing logic 420 may compare the power received from the primary power source 422, directly or through the UPS 300 (not shown), with the power received from the bypass power source 424. As discussed above, when the power received from the primary power source 422 experiences a power quality event actually meeting the predetermined power quality standard, then and only then does the sensing logic trigger the switches 414 and 416 to transfer to the bypass power source 424. In addition, the sensing logic 420 may monitor the phase of the power sources 422,424, and thereby precisely control the timing of the transfer.

It should be noted that use of the SCRs 418 makes any transfer much quicker when compared with more traditional contactors, such as that shown in FIG. 3. Therefore, use of the SCRs 418 minimizes any time that the power sources 422,424 would be operated in parallel and the associated stress on the UPS 300. However, even with near instantaneous transfer capability, it is still desirable to delay any transfer, giving the UPS 300 an opportunity to ride out any power quality event, provided the power supplied to the load 410 remains within the predetermined power quality standard. This is especially true where the power sources 422,424 have drastically different phases, which could lead to large saturation currents and other problems.

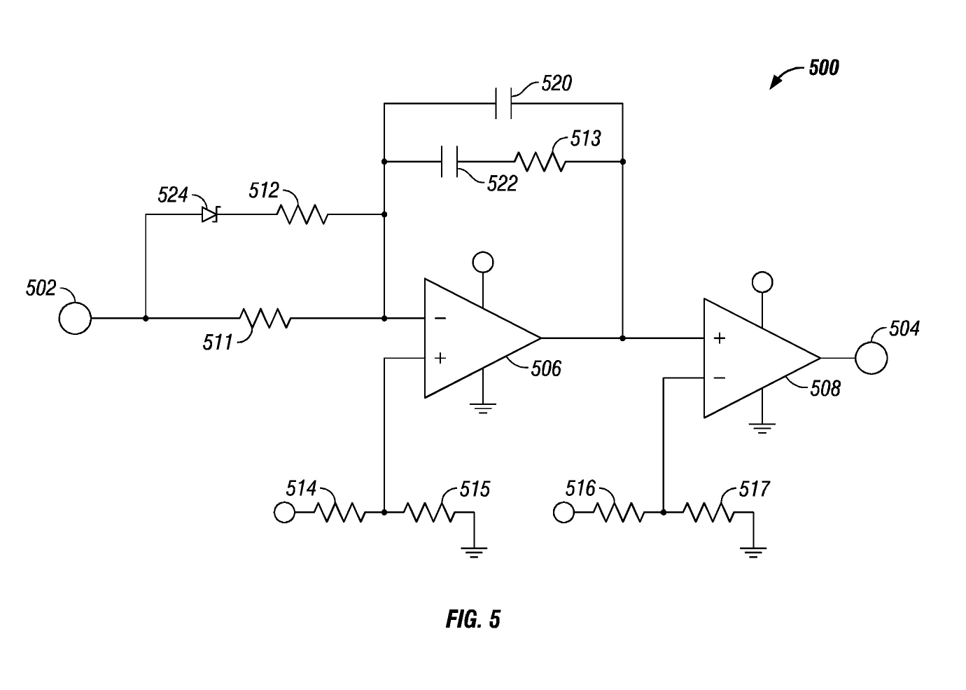

In any case, the sensing logic 420 of the transfer switch 408 or 308 preferably includes a detection circuit 500, such as that shown in FIG. 5. The detection circuit 500 includes a voltage input (Vin) 502 and a voltage output (Vout) 504. The Vin 502 is preferably a DC voltage signal representative of the RMS voltage value of the UPS 300 output. Alternatively, the Vin 502 may represent an RMS voltage value of the primary source 322,422 more directly. In any case, the Vin 502 may be derived by any of various common methods of voltage measurement that will yield a DC voltage signal which varies proportionally with the RMS value of an AC voltage. The Vout 504 is generated by the detection circuit 500 to indicate a power quality event, such as when the Vin 502 falls below the predetermined power quality standard, and is used to trigger the transfer switch 308,408 to transfer to the bypass power 324,424. For example, if the Vin 502 falls below the predetermined power quality standard, such as the CEBMA curve for the prescribed amount of time, the detection circuit 500 will generate the Vout 504, thereby initiating a transfer to the bypass power 324,424. The detection circuit 500 of the preferred embodiment includes an operational amplifier (U1) 506 and a comparator U2 508. The detection circuit 500 of a preferred embodiment also preferably includes seven resistors (R1,R2,R3,R4,R5,R6,R7) 511,512,513,514,515,516,517, two capacitors (C1,C2) 520,522, and one Zener diode (D1) 524.

R4 and R5 514,515 form a voltage divider to derive a reference voltage signal which is applied to the positive input terminal of U1 506. The values of R4 and R5 514,515 are preferably chosen such that this reference signal is equal to a Vin 502 voltage level that represents the minimum continuous RMS voltage that is considered to be acceptable by the predetermined power quality standard. In the case of the CBEMA curve this is approximately eighty-nine percent of nominal voltage. If, for example, the voltage measurement method that is used to represent the RMS value of the AC voltage generates a DC voltage that varies from 0 to 5 volts as the AC voltage varies from zero to nominal full voltage, then the values of R4 and R5 514,515 would be chosen to derive a reference voltage of 89% of 5 volts or 4.45 volts. In this case, if Vin 502 is above 4.45 volts, then the voltage applied to the negative input terminal of U1 506 through R1 511 will overcome the reference voltage applied to the positive input terminal of U1 506 and drive the output of U1 506 in a negative direction toward zero volts. Conversely, in this example, if Vin 502 is below 4.45 volts, then the reference voltage applied to the positive input terminal of U1 506 will overcome Vin 502 voltage applied to the negative input terminal of U1 506 and drive the output of U1 506 in a positive direction toward its positive supply voltage.

Similarly, R6 and R7 516,517 form another voltage divider that is used to derive a reference voltage signal that is applied to the negative input terminal of U2 508. This reference voltage level is chosen to be at some value below the positive supply voltage such that when the output voltage of U1 506, which is applied to the positive input terminal of U2 508, is above this reference voltage, the output of comparator U2 508, which is preferably Vout 504, will signal that an under voltage condition exists. Conversely, when the output voltage of U1 506 is below this reference voltage, the output of comparator U2 508, and hence Vout 504, will drop to zero volts signaling that an under voltage condition does not exist.

Thus, when Vin 502 is below the reference voltage for U1 506, the output of U1 506 is generally driven in a positive direction and it will eventually reach a voltage level sufficient to overcome the reference voltage of the comparator U2 508, thereby generating Vout 504 indicating an under voltage condition. However, it should be understood that the rate at which the output of U1 506 is driven in the positive direction will be determined by the magnitude of the difference between Vin 502 and the reference voltage for U1 506.

In more detail, when Vin 502 falls below the reference voltage at the positive input terminal of U1 506, a current flows through R1 511 in a direction from the negative input terminal of U1 506 toward Vin 502. This current is supplied from the output of U1 506 through capacitors C1 and C2 520,522 located in the feedback path of U1 506 and connecting the output of U1 506 to the negative input terminal of U1 506. The current flowing through the capacitors 520,522 will create a charge on the capacitors 520,522 such that a positive voltage is created at the output of U1 506. For a given value of R1 511, it can be seen that the magnitude of the current that flows through R1 511 will be dependant on the difference between the voltage at Vin 502 and the reference voltage for U1 506. If the difference between Vin 502 and this reference voltage is relatively small, then a relatively small current will flow through R1 511. If the difference between Vin 502 and this reference voltage is relatively large, then a relatively large current will flow through R1 511. In this way, it can be seen that the value of the voltage at Vin 502 will directly determine the rate at which C1 and C2 520,522 charge, and thus the rate at which the voltage at the output of U1 506 increases, and consequently the amount of time it takes to reach a voltage level sufficient to cause the comparator U2 508 to generate Vout 504 indicating an under voltage condition.

In general, the above described detection circuit 500 provides the desired behavior since the CBEMA curve dictates that the period of time allowed for low voltages is relatively short while the period of time allowed for higher voltages is relatively long. However, there is a non-linearity in the CBEMA curve such that the relationship between source RMS voltage level and the time allowed for that voltage level is not directly proportional. When the source voltage is very low, the CEBEMA curve has a disproportionately shorter time allowed. Additionally, when the source voltage is only slightly low, the CEBEMA curve has a disproportionately longer time allowed. The addition of R2, R3, and D1 512,513,524 into the detection circuit 500 incorporates this behavior into the circuit.

Very Low Voltages

Normally, when Vin 502 is less than the reference voltage of U1 506, the amount of current flowing in the detection circuit 500 is determined by the value of R1 511. However, if the difference between Vin 502 and the reference voltage 506 becomes large enough to cause Zener diode D1 524 to conduct, current will also flow in R2 512, increasing the total current and thus the rate at which the voltage at the output of U1 506 increases.

Slightly Low Voltages

The rate at which the U1 506 output voltage increases is affected by the amount of capacitance in the feedback path of U1 506. The total amount of capacitance in the charging current flow path is fundamentally determined by the combined capacitance of C1 and C2 520,522. However, the addition of R3 513 in series with C2 522 allows C2 522 to have a more significant effect when the charging current is relatively small. At small currents, R3 513 will drop essentially no voltage, and thus it can be considered to have little effect on the circuit. In this case, the effective total capacitance value is approximately the sum of C1 and C2 502,522. With increasing values of charging current R3 513 will drop a more significant voltage and C2 522 adds less to the effective total capacitance. In this case, the effective total capacitance is less than the sum of C1 and C2 502,522. This causes smaller currents to result in a disproportionately slower rate of voltage increase at the output of U1 506.

While the preferred embodiment used the CBEMA curve as the predetermined power quality standard, other standards may be used. For example, the detection circuit 500 may be designed to track the standards set forth by the Information Technology Industry Counsel (ITIC) and/or the Semiconductor Equipment and Materials International (SEMI). The detection circuit 500 may also be designed to track some custom standard designed around, or specified by, the load 310,410.

In any case, it can be seen that by proper selection of the values of the detection circuit 500 components, a circuit behavior can be created that closely replicates the limits dictated by virtually any power quality standard. Because the preferred embodiment utilizes the CBEMA curve as the predetermined power quality standard, the following component values have been found to be effective: R1=47.5 k Ohms; R2=10 k Ohms R3=130 k Ohms; C1=0.22 uF; C2=2.2 uF; and D1=4.3 Volts. In an alternative embodiment, designed to utilize the ITIC curve, the following component values have been found to be effective: R1=47.5 k Ohms; R3=160 k Ohms; C1=0.01 uF; and C2=3.3 uF; with R2 and D1 being unnecessary. However, due to the extreme non-linearity of the ITIC curve, the performance of the detection circuit 500 is much more sensitive to component value tolerances as compared with the CBEMA curve. For at least this reason, the preferred embodiment utilizes the CBEMA curve as the predetermined power quality standard.

In operation, when the RMS input voltage Vin 502 falls outside of the acceptable power quality standard, the detection circuit 500 generates a signal, Vout 504, that is communicated to the transfer switch 308,408 and the load 310,410 is transferred from the primary power source 322,422 to the bypass source 324,424. So long as the RMS input voltage Vin 502 remains within the acceptable power quality standards, such as within the acceptable volts-seconds region defined by the CBEMA curve, the detection circuit 500 does not communicate a signal to the transfer switch 308,408.

Additionally, while in the preferred embodiment, the detection circuit 500 is implemented with fixed value components, the functions of the detection circuit 500 may be performed in a more flexible manner. For example, it should be obvious to those skilled in the art, that the same function, or any part thereof, could be implemented in a software algorithm using a microcontroller, microprocessor, or any programmable digital device or any combination of digital and analog electronic circuitry. In other words, the detection circuit 500 could include a microprocessor to perform one or more of the functions described above. Such computerization would permit switching between any one of a number of preprogrammed power quality standards using substantially the same hardware. Alternatively, the microprocessor could choose among different detection circuits each designed for a different power quality standard.

Therefore, the detection circuit 500, or microprocessor, could choose which standard to apply, depending on the load 312,412. For example, the load 312,412 may communicate its own power quality requirements to the detection circuit 500, or microprocessor, which then reconfigures itself or otherwise selects an appropriate circuit or code segment to adapt to that power quality requirement. Alternatively, or additionally, a user may provide or select a power quality standard through a user interface.

Where more than one load 312,412 is being supplied through the UPS 300, or from the primary source 322,422, the detection circuit 500 may choose and utilize the most conservative power quality requirement of those provided, or any portions thereof For example, a first load may be more tolerant of overvoltage conditions, but less tolerant of undervoltage conditions, when compared with a second load. In this case, the present invention would preferably choose the undervoltage power quality requirements from the first load and the overvoltage power quality requirements from the second load.

It should also be noted that while the present invention has been described primarily with respect to undervoltage conditions, the same principals may be applied to overvoltage conditions. Furthermore, any specific embodiment of the present invention preferably reacts to both undervoltage and overvoltage conditions in a manner to prevent disruption or damage to the load, while delaying a transfer as long as practical in order to minimize potential problems encountered during transfer, as described above.

While the detection circuit 500 has been described as being integral to the transfer switch 308,408, the detection circuit 500 may be completely independent thereof For example, the detection circuit 500 may be a stand-alone device or may be integrated into the UPS 300 or some other component.

Other and further embodiments utilizing one or more aspects of the inventions described above can be devised without departing from the spirit of Applicant's invention. For example, the invention may be implemented solely in software, soley in firmware, solely in hardware, or in any combination of software, firmware and hardware.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method of increasing the reliability of an uninterruptible power supply (UPS) providing AC power to a load, comprising:
monitoring a magnitude of an input voltage;
comparing, over time, the magnitude of the input voltage with a predetermined standard establishing an acceptable voltage magnitude with respect to duration; and
causing the load to be transferred to an alternate source of AC power when the comparison reveals that the input voltage does not meet the standard with respect to both magnitude and duration.

2. The method of claim 1, wherein the predetermined standard is specific for the load.

3. The method of claim 1, wherein the predetermined standard is the Computer and Business Equipment Manufacturers Association (CBEMA) curve.

4. The method of claim 1, wherein the predetermined standard is the Information Technology Industry Counsel (ITIC) curve.

5. The method of claim 1, wherein the transfer is delayed until the input voltage matches both the magnitude and duration defined by the predetermined standard.

6. The method of claim 1, wherein the input voltage is monitored by a detection circuit which generates a transfer signal when the input voltage meets or exceeds the magnitude for the duration specified by the standard.

7. The method of claim 6, wherein the detection circuit does not generate the signal until the input voltage meets or exceeds the magnitude for the duration specified by the standard.

8. The method of claim 1, wherein the load is not transferred as long as the input voltage remains within an acceptable area of the standard with respect to both magnitude and duration.

9. The method of claim 1, wherein the wherein the load is transferred upon the input voltage reaching an overvoltage area of the standard with respect to both magnitude and duration.

10. The method of claim 1, wherein the wherein the load is transferred upon the input voltage reaching an undervoltage area of the standard with respect to both magnitude and duration.

11. A method of increasing the reliability of an uninterruptible power supply (UPS) providing AC power to a load, comprising:
determining the magnitude and duration of an actual undervoltage event in a power output of the UPS;
providing a predetermined undervoltage standard establishing at least a range of undervoltage events of acceptable magnitude and duration for the load;
comparing the magnitude and duration of the actual undervoltage event with the predetermined standard; and
causing the load to be transferred to an alternate source of AC power when the comparison of the actual undervoltage event with the predetermined standard reveals that the actual undervoltage event is not acceptable.

12. The method of claim 11, wherein the predetermined standard is specific for the load.

13. The method of claim 11, wherein the predetermined standard is the Computer and Business Equipment Manufacturers Association (CBEMA) curve.

14. The method of claim 11, wherein the predetermined standard is the Information Technology Industry Counsel (ITIC) curve.

15. The method of claim 11, wherein the transfer is delayed until the actual undervoltage event matches both the magnitude and duration defined by the predetermined standard.

16. The method of claim 11, wherein the input voltage is monitored by a detection circuit which generates a transfer signal when the input voltage meets or exceeds the magnitude for the duration specified by the standard.

17. The method of claim 16, wherein the detection circuit does not generate the signal until the input voltage meets or exceeds the magnitude for the duration specified by the standard.

18. The method of claim 11, wherein the load is not transferred as long as the input voltage remains within an acceptable area of the standard with respect to both magnitude and duration.

19. The method of claim 11, wherein the wherein the load is transferred upon the input voltage reaching an undervoltage area of the standard with respect to both magnitude and duration.

20. A method of increasing the reliability of an uninterruptible power supply (UPS) providing AC power to a load, comprising:
monitoring a magnitude of an input voltage;
determining a magnitude and duration of an actual undervoltage event of the input voltage;
comparing the event with a predetermined standard establishing at least a range of undervoltage events of acceptable magnitude and duration; and
causing the load to be transferred to an alternate source of AC power when the comparison reveals that the input voltage does not meet the standard, wherein the transfer is delayed until the input voltage does not meet the standard thereby avoiding premature transfer.
